(19) United States
(12) Patent Application Publication
(10) Pub. No.: US 2007/0059616 A1
(43) Pub. Date: Mar. 15, 2007

(54) Coated substrate for photoreceptor

(75) Inventors: Satchidanand Mishra, Webster, NY (US); Anthony M. Horgan, Pittsford, NY (US); Kent J. Evans, Lima, NY (US); George Liebermann, Mississauga (CA); Ah-Mee Hor, Mississauga (CA); Min-Hong Fu, Webster, NY (US); Richard L. Post, Penfield, NY (US); Kathleen M. Carmichael, Williamson, NY (US); Satish R. Parikh, Rochester, NY (US); Edward F. Grabowski, Webster, NY (US); Donald J. Goodman, Pittsford, NY (US); Gregory J. Kovacs, Webster, NY (US)

Correspondence Address: OLIFF & BERRIDGE, PLC., P.O. BOX 19928, ALEXANDRIA, VA, 22320, US

(73) Assignee: Xerox Corporation, Stamford, CT (US)

(21) Appl. No.: 11/223,014

(22) Filed: Sep. 12, 2005

(51) Int. Cl. G03G 15/00

(52) U.S. Cl. 430/56; 430/57.2; 430/58.5

(57) ABSTRACT

An imaging member includes a conductive substrate, a SiOx layer coated over the conductive substrate, a charge generating layer coated over the SiOx layer, and a charge transport layer

### BACKGROUND

The present disclosure relates to improved photoreceptor designs for electrostatographic printing devices, particularly photoreceptors having a coated substrate layer, which provides improved photoreceptor operation. More particularly, the present disclosure relates to photoreceptors having a composite substrate layer of silicon oxide, identified here as SiOx, coated over a conductive layer of the substrate, which coating reduces the occurrence or the effect of charge deficient spots in the photoreceptor.

In electrophotography, also known as Xerography, electrophotographic imaging or electrostatographic imaging, the surface of an electrophotographic plate, drum, belt or the like (imaging member or photoreceptor) containing a photoconductive insulating layer on a conductive layer is first uniformly electrostatically charged. The imaging member is then exposed to a pattern of activating electromagnetic radiation, such as light or a laser emission. The radiation selectively dissipates the charge on the illuminated areas of the photoconductive insulating layer while leaving behind an electrostatic latent image on the non-illuminated areas. This electrostatic latent image may then be developed to form a visible image by depositing finely divided electroscopic marking particles on the surface of the photoconductive insulating layer. The resulting visible image may then be transferred from the imaging member directly or indirectly (such as by a transfer or other member) to a print substrate, such as transparency or paper. The imaging process may be repeated many times with reusable imaging members.

An electrophotographic imaging member may be provided in a number of forms. For example, the imaging member may be a homogeneous layer of a single material such as vitreous selenium or it may be a composite layer containing a photoconductor and another material. In addition, the imaging member may be layered. Current layered organic imaging members generally have at least a substrate layer, a ground plane, and two active layers. These active layers generally include (1) a charge generating layer containing a light-absorbing material that generates charges, and (2) a charge transport layer containing electron donor molecules. These charge generating and charge transport active layers can be in any order, depending on the desired charge polarity, and sometimes can be combined in a single or mixed layer. The substrate layer may be formed from a conductive material, or a conductive layer can be formed on a nonconductive substrate.

The charge generating layer is capable of photogenerating charge and injecting the photogenerated charge into the charge transport layer. For example, U.S. Pat. No. 4,855,203 to Miyaka teaches charge generating layers comprising a resin dispersed pigment. Suitable pigments include photoconductive zinc oxide or cadmium sulfide and organic pigments such as phthalocyanine type pigment, a polycyclic quinone type pigment, a perylene pigment, an azo type pigment and a quinacridone type pigment. Imaging members with perylene charge generating pigments, particularly benzimidazole perylene, show superior performance with extended life.

In the charge transport layer, the electron donor molecules may be in a polymer binder. In this case, the electron donor molecules provide hole or charge transport properties, while the electrically inactive polymer binder largely provides mechanical properties. Alternatively, the charge transport layer can be made from a charge transporting polymer such as poly(N-vinylcarbazole), polysilylene or polyether carbonate, wherein the charge transport properties are incorporated into the mechanically strong polymer.

Imaging members may also include a charge blocking layer and/or an adhesive layer between the charge generating layer and the conductive layer. In addition, imaging members may contain protective overcoatings. Further, imaging members may include layers to provide special functions such as incoherent reflection of laser light, dot patterns and/or pictorial imaging or subbing layers to provide chemical sealing and/or a smooth coating surface.

As more advanced, higher speed electrophotographic copiers, duplicators and printers have been developed, and as the use of such devices increases in both the home and business environments, degradation of image quality has been encountered during extended cycling. Moreover, complex, highly sophisticated duplicating and printing systems operating at very high speeds have placed stringent requirements upon component parts, including such constraints as narrow operating limits on the photoreceptors. For example, the numerous layers found in many moderm photoconductive imaging members must be highly flexible, adhere well to adjacent layers, and exhibit predictable electrical characteristics within narrow operating limits to provide excellent toner images over many thousands of cycles without degradation in the print quality or mechanical disintegration such as cracking and abrasion. One type of multilayered photoreceptor that has been employed for use as a belt or as a roller in electrophotographic imaging systems comprises a substrate, a conductive layer, a blocking layer, an adhesive layer, a charge generating layer, a charge transport layer and a conductive ground strip layer adjacent to one edge of the imaging layers. This photoreceptor may also comprise additional layers such as an anti-curl back coating and an optional overcoating layer.

Although excellent toner images may be obtained with multilayered belt or drum photoreceptors, it has been found that as more advanced, higher speed electrophotographic copiers, duplicators and printers are developed, there is a greater demand on copy quality. A delicate balance in charge, discharge, and bias potentials, and characteristics of the toner and/or developer, must be maintained. This places additional constraints on the quality of photoreceptor manufacturing, and thus adds an additional constraint on manufacturing yield.

In certain combinations of materials for photoreceptors, or in certain production batches of photoreceptor materials including the same kind of materials, localized microdefect sites (which may vary in size from about 50 to about 200 microns) can occur. Using photoreceptors fabricated from these materials, where the dark decay is high compared to spatially uniform dark decay present in the sample, these sites appear as print defects (microdefects) in the final imaged copy. In charged area development, where the charged areas are printed as dark areas, the sites print out as white spots. These microdefects are called microwhite spots. Likewise, in discharged area development systems, where the exposed area (discharged area) is printed as dark areas, these sites print out as dark spots in a white background. All of these microdefects, which exhibit inordinately large dark decay, are called charge deficient spots (or CDS).

Because the microdefect sites are fixed in the photoreceptor, the spots are registered from one cycle of belt revolution to the next. Whether these localized microdefect or charge deficient spot sites will show up as print defects in the final document will depend on the development system utilized and, thus, on the machine design selected. For example, some of the variables governing the final print quality include the surface potential of the photoreceptor, the image potential of the photoreceptor, the photoreceptor to development roller spacing, toner characteristics (such as size, charge and the like), the bias applied to the development rollers, and the like. The image potential depends on the light level selected for exposure. The defect sites are discharged, however, by the dark discharge rather than by the light. The copy quality from generation to generation is maintained in a machine by continuously adjusting some of the parameters with cycling. Thus, defect levels could also change with cycling.

Furthermore, cycling of belts made up of identical materials but differing in overall belt size and use in different copiers, duplicators and printers has exhibited different microdefects. Moreover, belts from different production runs have exhibited different microdefects when initially cycled in any given copier, duplicator and printer.

Various methods have been developed in the art to assess and/or accommodate the occurrence of the charge deficient spots. For example, U.S. Pat. Nos. 5,703,487 and 6,008,653 disclose processes for ascertaining the microdefect levels of an electrophotographic imaging member. The method of U.S. Pat. No. 5,703,487 comprises the steps of measuring either the differential increase in charge over and above the capacitive value or measuring reduction in voltage below the capacitive value of a known imaging member and of a virgin imaging member and comparing differential increase in charge over and above the capacitive value or the reduction in voltage below the capacitive value of the known imaging member and of the virgin imaging member.

U.S. Pat. No. 6,008,653 discloses a method for detecting surface potential charge patterns in an electrophotographic imaging member with a floating probe scanner. The scanner includes a capacitive probe, which is optically coupled to a probe amplifier, and an outer Faraday shield electrode connected to a bias voltage amplifier. The probe is maintained adjacent to and spaced from the imaging surface to form a parallel plate capacitor with a gas between the probe and the imaging surface. A constant voltage charge is applied to the imaging surface prior to establishing relative movement of the probe and the imaging surface. Variations in surface potential are measured with the probe and compensated for variations in distance between the probe and the imaging surface. The compensated voltage values are compared to a baseline voltage value to detect charge patterns in the electrophotographic imaging member. U.S. Pat. No. 6,119,536 describes the floating probe used in these measurements.

U.S. Pat. Nos. 5,591,554 and 5,576,130 disclose methods for preventing charge injection from substrates that give rise to CDS's. These patents disclose an electrophotographic imaging member including a support substrate having a two layered electrically conductive ground plane layer comprising a layer comprising zirconium over a layer comprising titanium, a hole blocking layer, and an adhesive layer. U.S. Pat. No. 5,591,554 describes an adhesive layer which includes a copolyester film forming resin, and an intermediate layer comprising a carbazole polymer, on which is coated a charge generation layer comprising a perylene or a phthalocyanine, and a hole transport layer, which is substantially non-absorbing in the spectral region at which the charge generation layer generates and injects photogenerated holes. U.S. Pat. No. 5,576,130 describes an adhesive layer that comprises a thermoplastic polyurethane film forming resin.

In preparing electrophotographic imaging members, use of silicon or silane materials is known. For example, U.S. Pat. No. 5,352,555 discloses an electrophotographic photoreceptor comprising an electroconductive support of specified hardness, a photoconductive layer comprising amorphous silicon containing at least one of hydrogen and halogen; and a surface layer comprising at least one of an amorphous silicon layer containing at least one of nitrogen, oxygen, and carbon, and an amorphous carbon layer containing at least one of hydrogen and halogen. U.S. Pat. No. 5,737,671 discloses an electrophotographic photoreceptor comprising a transparent substrate, a transparent conductive layer, a thin film intermediate layer made of semiconductor material or semiconductor insulating material formed by a vacuum deposition method, and an amorphous silicon photoconductive layer. U.S. Pat. No. 5,592,274 discloses a photoreceptor having a surface protecting layer and a light-sensitive layer made of a hydrogenated and/or fluorinated amorphous silicon.

### SUMMARY

Despite the various known photoreceptor designs, there remains a need in the art for methods to reduce the occurrence of charge deficient spots in the first instance and/or to mitigate their effect in the photoreceptor during use. If the occurrence of charge deficient spots can be reduced or eliminated, or if their effect in the photoreceptor during use can be mitigated, then resultant print quality using the photoreceptors will increase and photoreceptor production yield should also increase. Longer photoreceptor useful life is particularly desired, for example, because it makes image development and machine service more cost effective, and provides increased customer satisfaction.

The present disclosure addresses these and other needs by providing an improved photoreceptor design, comprising a SiOx layer coated on the conductive substrate layer. The SiOx coating suppresses charge injection from the conductive substrate, particularly the conductive ground plane and at localized sites.

In particular, the present disclosure provides an imaging member comprising:

a conductive substrate,

a silicon oxide layer coated over said conductive substrate;

a charge generating layer coated over said SiOx layer, and

a charge transport layer.

The present disclosure also provides a process for forming an imaging member, comprising:

providing an imaging member conductive substrate,

applying a silicon oxide layer coated over said conductive substrate; and

applying at least a charge generating layer and a charge transport layer over said SiOx layer.

In embodiments, the imaging member can also comprise additional layers, such as a blocking layer, an adhesive layer, and anti-curl back coating layer, and the like. In embodiments, a blocking layer can be coated and provided over the SiOx layer, i.e., between the SiOx layer and the charge generating layer, to provide improved CDS reduction.

### BRIEF DESCRIPTION OF THE DRAWINGS

These and other advantages and features of this disclosure will be apparent from the following, especially when considered with the accompanying drawings, in which:

The FIGURE is an exemplary diagram of a cross-section of an imaging member.

### DETAILED DESCRIPTION OF PREFERRED EMBODIMENTS

The present disclosure relates to imaging members (photoreceptors) comprising a SiOx layer coated over the substrate or conductive ground plane layer.

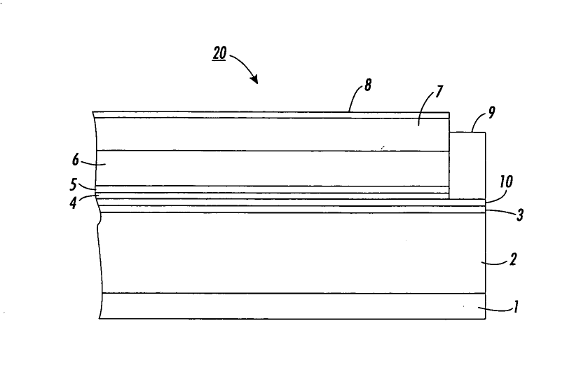

Embodiments of the present disclosure are shown in FIG. 1, which is an exemplary diagram of a cross-section of an imaging member 20. The imaging member 20 may include an anti-curl layer 1, a substrate 2, an electrically conductive ground plane 3, a SiOx layer 10 coated over the conductive ground plane 3, a charge-blocking layer 4, an adhesive layer 5, a charge-generating layer 6, a charge-transport layer 7, an overcoating layer 8, and a ground strip 9. Although the imaging member 20 is shown as a photoreceptor, it should be appreciated that the imaging member 20 may be any member that forms or receives an image, and may include more or less layers without departing from the spirit and scope. This imaging member can be employed in an imaging process comprising providing the electrophotographic imaging member, depositing a uniform electrostatic charge on the imaging member with a corona charging device, exposing the imaging member to activating radiation in image configuration to form an electrostatic latent image on the imaging member, developing the electrostatic latent image with electrostatically attractable toner particles to form a toner image, transferring the toner image to a receiving member and repeating the depositing, exposing, developing and transferring steps. These imaging members may be fabricated by any of the various known methods.

In general, electrostatographic imaging members are well known in the art. An electrostatographic imaging member, including the electrostatographic imaging member of the present disclosure, may be prepared by any of the various suitable techniques, provided that a silicon oxide, referred to herein as SiOx, coating is provided over the substrate, and particularly over the conductive ground plane as described below. Suitable conventional photoreceptor designs that can be modified in accordance with the present disclosure to include the additional SiOx layer include, but are not limited to, those described for example in U.S. Pat. Nos. 4,265,990, 4,233,384, 4,306,008, 4,299,897, 4,439,507, 6,350,550, 6,376,141, 5,607,802, 5,591,554, 4,647,521, 4,664,995, 4,713,308, and 5,008,167, the entire disclosures of which are incorporated herein by reference.

U.S. Pat. Nos. 4,265,990, 4,233,384, 4,306,008, 4,299,897, and 4,439,507 disclose electrophotographic imaging members having at least two electrically operative layers including a charge generating layer and a transport layer comprising a diamine. U.S. Pat. No. 6,350,550 describes an electrophotographic member with mixed pigments. U.S. Pat. No. 6,376,141 describes an electrophotographic member with dual charge generating layers to enhance the sensitivity as well as the wavelength response. U.S. Pat. No. 5,830,614 relates to an imaging member comprising a support layer, a charge generating layer, a dual charge transport layer; the first layer in direct contact with the generator layer has higher concentration of charge transporting molecules than the second charge transporting layer coated on the top of the first charge transporting layer. U.S. Pat. No. 5,607,802 describes a multi-layered photoreceptor with dual under layers for improved adhesion and reduced micro-defects. In U.S. Pat. No. 5,591,554 an electrophotographic imaging member is disclosed including a support substrate having a two layered electrically conductive ground plane layer comprising a layer comprising zirconium over a layer comprising titanium a hole blocking layer, an adhesive layer comprising a copolyester film forming resin, an intermediate layer over and in contact with the adhesive layer, the intermediate layer comprising a carbazole polymer, a charge generation layer comprising a perylene or a phthalocyanine, and a hole transport layer. The entire disclosure of these patents is incorporated herein by reference in their entirety. These photoreceptor designs can also be modified in accordance with the present disclosure.

The particular construction of an exemplary imaging member will now be described in more detail. However, the following discussion is of only one embodiment, and is not limiting of the disclosure.

The substrate 1 may be opaque or substantially transparent and may comprise numerous suitable materials having the required mechanical properties. Accordingly, the substrate may comprise a layer of an electrically non-conductive or conductive material such as an inorganic or an organic composition. As electrically non-conducting materials there may be employed various resins known for this purpose including, but not limited to, polyesters, polycarbonates, polyamides, polyurethanes, mixtures thereof, and the like. As electrically conductive materials there may be employed various resins that incorporate conductive particles, including, but not limited to, resins containing an effective amount of carbon black, or metals such as copper, aluminum, nickel, and the like. The substrate can be of either a single layer design, or a multi-layer design including, for example, an electrically insulating layer having an electrically conductive layer applied thereon.

The electrically insulating or conductive substrate is preferably in the form of a rigid cylinder, drum or belt. In the case of the substrate being in the form of a belt, the belt can be seamed or seamless, with a seamless belt being particularly preferred.

The thickness of the substrate layer depends on numerous factors, including strength and rigidity desired and economical considerations. Thus, this layer may be of substantial thickness, for example, about 5000 micrometers or more, or of minimum thickness of less than or equal to about 100 micrometers, or anywhere in between, provided there are no adverse effects on the final electrostatographic device. The surface of the substrate layer is preferably treated prior to coating to promote greater adhesion of the deposited coating. Pretreatment may be effected by any known process including, for example, by exposing the surface of the substrate layer to plasma discharge, ion bombardment and the like.

The conductive layer may vary in thickness over substantially wide ranges depending on the optical transparency and degree of flexibility desired for the electrostatographic member. Accordingly, for a photoresponsive imaging device having an electrically insulating, transparent cylinder, the thickness of the conductive layer may be between about 10 angstrom units to about 500 angstrom units, and more preferably from about 10 angstrom units to about 200 angstrom units for an optimum combination of electrical conductivity and light transmission.

The conductive layer may be an electrically conductive metal layer formed, for example, on the substrate by any suitable coating technique, such as a vacuum depositing technique, sputtering. Typical metals include, but are not limited to, aluminum, zirconium, niobium, tantalum, vanadium and hafnium, titanium, nickel, stainless steel, chromium, tungsten, molybdenum, mixtures thereof, and the like. In general, a continuous metal film can be attained on a suitable substrate, e.g. a polyester web substrate such as Mylar available from E. I. du Pont de Nemours & Co., with magnetron sputtering.

If desired, an alloy of suitable metals may be deposited. Typical metal alloys may contain two or more metals such as zirconium, niobium, tantalum, vanadium and hafnium, titanium, nickel, stainless steel, chromium, tungsten, molybdenum, and the like, and mixtures thereof.

Regardless of the technique employed to form the metal layer, a thin layer of metal oxide generally forms on the outer surface of most metals upon exposure to air. Thus, when other layers overlying the metal layer are characterized as “contiguous” (or adjacent or adjoining) layers, it is intended that these overlying contiguous layers may, in fact, contact a thin metal oxide layer that has formed on the outer surface of the oxidizable metal layer. Generally, for rear erase exposure, a conductive layer light transparency of at least about 15 percent is desirable. The conductive layer need not be limited to metals. Other examples of conductive layers may be combinations of materials such as conductive indium tin oxide as a transparent layer for light having a wavelength between about 4000 Angstroms and about 7000 Angstroms or a conductive carbon black dispersed in a plastic binder as an opaque conductive layer. A typical electrical conductivity for conductive layers for electrophotographic imaging members in slow speed copiers is about 10² to 10³ ohms/square.

After formation of an electrically conductive surface, or conductive ground plane over the substrate, a SiOx coating is applied over the conductive layer. SiOx, alternatively referred to as silica or silicon oxide, is a chemical species comprising silicon and oxygen atoms bonded in various proportions, depending upon the specific application method and precursor species used. Thus, for example, the ratio “x” in SiOx can range from as low as about 0.01 or less, about 0.05, or about 0. 1, to as high as about 1.5, about 1.8, or about 2.o or more. In embodiments, the SiOx is at a stoichiometric, or almost stoichiometric, ratio. “SiOx” is thus conventionally used in the art to refer to these silicon oxide species, with the varying silicon/oxygen ratios.

In embodiments, incorporation of such an SiOx layer reduces the undesirable effects attributed to the occurrence of charge deficient spots in the photoreceptor. In particular, it has been found that certain localized spots in the conductive ground plane inject charge into the overlying charge generating layer. These localized spots give rise to the micro defects in the discharged area described as “charge deficient spots.” However, interposing an SiOx layer between the conductive ground plane and the charge generating and charge transport layers has been found to reduce the inordinately high injection from these spots without affecting too much the injection from other areas. Thus, while not eliminating the charge deficient spots themselves, the SiOx layer attenuates or eliminates their effects, thereby rendering their existence less of a concern in terms of print quality. In embodiments, the SiOx may also cover sharp filaments that are sometimes accidentally formed during metallization processes, and hence suppress resultant dark injection from these protrusions.

The SiOx layer can be applied by any suitable method used in the art. For example, the SiOx layer can be applied to the underlying conductive layer by methods such as sputtering, e-beam deposition, thermal evaporation vapor deposition, chemical vapor deposition (CVD) including plasma-assisted CVD, or ion plating. Such methods may be conducted in the well-known manners, including such precursor materials as, for example, silicon oxide based coating material, silanes, in particular, SiH₄ and/or Si₂H₆ as primary feed gases containing silicon atoms, and O₂, N₂O, CO and CO₂ as oxygen-containing feed gases. These methods may thus form a composite layer, comprising the conductive layer and the SiOx layer.

While any of these methods may be suitable used in some embodiments, sputtering or e-beam deposition processes are preferred in other embodiments.

In addition, it has been found that SiOx layers provided by sputtering provide further advantages. First, SiOx layers provided by sputtering or e-beam deposition have a more dense structure and continuous structure without any voids, and thus provide increased charge injection blocking in the imaging member. Second, the sputtered or e-beam deposited coatings are more resistant to scratches, which decreases the losses of devices in transport. Third, sputtering treatment and processing equipment are more readily available than other deposition methods and treatment, enabling more wide-spread use. Fourth, sputtering processes are less susceptible to environmental contamination than, for example, e-beam deposition processes. Sputtered films also generally have adhesion to substrate superior to evaporation deposited films due to the high energy of sputtered particles. Typically, particle energy from evaporation sources lie in the range of 0.1 to 0.3 eV while for sputtering sources particles have energy in the range of 10 to 40 eV. Finally, sputtering processes are about an order of magnitude cheaper than processes such as e-beam deposition, thus making sputtering more cost effective.

The SiOx layers can be formed at any suitable thickness, to provide the desired charge injection blocking. For example, the SiOx layer can have a thickness of from about 10 to about 500 Angstroms, such as from about 20 or about 35 Angstroms to about 100 or about 200 Angstroms, or from about 50 to about 75 Angstroms. However, thicknesses outside of these ranges, including thinner or thicker layers, can be used if desired. For example, thin layers having a thickness of less than about 150 Angstroms, such as from about 50 to about 150 Ansgtroms are suitable in some embodiments, while thicker layers having a thickness of more than about 150 Angstroms, such as from about 150 to about 500 Ansgtroms, are suitable in other embodiments.

Although the silicon oxide or SiOx layer is described above as containing SiOx species, the layer can consist only of such species, or it can consist essentially of such species, where the layer contains primarily SiOx species but also includes a minor, ineffective amount of impurities or other materials. In embodiments, however, the layer can also include other silicon species, such as silicon nitrides (SiNx), silicon carbides (SiCx), and the like.

After formation of the SiOx layer over the electrically conductive surface, a hole blocking layer may optionally be applied thereto for photoreceptors. Any suitable blocking layer capable of forming an electronic barrier to holes between the adjacent photoconductive (charge generating) layer and the underlying SiOx and conductive substrate layers may be utilized. The blocking layer may include film forming polymers, such as nylon, epoxy and phenolic resins. The polymeric blocking layer may also contain metal oxide particles, such as titanium dioxide or zinc oxide. The blocking layer may also include, but is not limited to, nitrogen containing siloxanes or nitrogen containing titanium compounds such as trimethoxysilyl propylene diamine, hydrolyzed trimethoxysilyl propyl ethylene diamine, N-beta(aminoethyl) gamma-amino-propyl trimethoxy silane, isopropyl 4-aminobenzene sulfonyl, di(dodecylbenzene sulfonyl)titanate, isopropyl di(4-aminobenzoyl)isostearoyl titanate, isopropyl tri(N-ethylaminoethylamino)titanate, isopropyl tri(N,N-dimethyl-ethylamino)titanate, titanium-4-amino benzene sulfonat oxyacetate, titanium 4-aminobenzoate isostearate oxyacetate, [H₂N(CH₂)₄]CH₃Si(OCH₃)₂, (gamma-aminobutyl)methyl diethoxysilane, [H₂N(CH₂)₃]CH₃Si(OCH₃)₂ (gamma-aminopropyl)methyl diethoxysilane, mixtures thereof, and the like, as disclosed in U.S. Pat. No. 4,291,110. Also suitable is a siloxane film, such as disclosed in U.S. Patent No. 4,464,450, which describes the use of a siloxane film comprising a reaction product of hydrolyzed siloxane or silane such as 3-aminotriethoxylsilane as a charge blocking layer coated on the ground plane. The entire disclosures of these patents are incorporated herein by reference.

The blocking layer can be further doped with fillers, such as metal oxides, to improve its finctionality. The blocking layer may be applied by any suitable conventional technique such as spraying, dip coating, draw bar coating, gravure coating, silk screening, air knife coating, reverse roll coating, vacuum deposition, chemical treatment and the like. For convenience in obtaining thin layers, the blocking layers are preferably applied in the form of a dilute solution, with the solvent being removed after deposition of the coating by conventional techniques such as by vacuum, heating and the like.

The blocking layers should be continuous and have a thickness of less than about 15 micrometer because greater thicknesses may lead to undesirably high residual voltage.

An optional adhesive layer may be applied to the hole blocking layer. Any suitable adhesive layer well known in the art may be utilized. Typical adhesive layer materials include, for example, but are not limited to, polyesters, dupont 49,000 (available from E. I. dupont de Nemours and Company), Vitel PE100 (available from Goodyear Tire & Rubber), polyurethanes, and the like. Satisfactory results may be achieved with adhesive layer thickness between about 0.05 micrometer (500 angstrom) and about 0.3 micrometer (3,000 angstroms). Conventional techniques for applying an adhesive layer coating mixture to the charge blocking layer include spraying, dip coating, roll coating, wire wound rod coating, gravure coating, Bird applicator coating, and the like. Drying of the deposited coating may be effected by any suitable conventional technique such as oven drying, infra red radiation drying, air drying and the like.

Any suitable photogenerating layer may be applied to the adhesive or blocking layer, which in turn can then be overcoated with a contiguous hole (charge) transport layer as described hereinafter. Examples of typical photogenerating layers include, but are not limited to, inorganic photoconductive particles such as amorphous selenium, trigonal selenium, and selenium alloys selected from the group consisting of selenium-tellurium, selenium-tellurium-arsenic, selenium arsenide and mixtures thereof, and organic photoconductive particles including various phthalocyanine pigment such as the X-form of metal free phthalocyanine described in U.S. Pat. No. 3,357,989, metal phthalocyanines such as vanadyl phthalocyanine and copper phthalocyanine, dibromoanthanthrone, squarylium, quinacridones available from Dupont under the tradename Monastral Red, Monastral violet and Monastral Red Y, Vat orange 1 and Vat orange 3 trade names for dibromo anthanthrone pigments, benzimidazole perylene, perylene pigments as disclosed in U.S. Pat. No. 5,891,594, the entire disclosure of which is incorporated herein by reference, substituted 2,4-diamino-triazines disclosed in U.S. Pat. No. 3,442,781, polynuclear aromatic quinones available from Allied Chemical Corporation under the tradename Indofast Double Scarlet, Indofast Violet Lake B, Indofast Brilliant Scarlet and Indofast Orange, and the like dispersed in a film forming polymeric binder. Multi-photogenerating layer compositions may be utilized where a photoconductive layer enhances or reduces the properties of the photogenerating layer. Examples of this type of configuration are described in U.S. Pat. No. 4,415,639, the entire disclosure of which is incorporated herein by reference. Other suitable photogenerating materials known in the art may also be utilized, if desired.

Charge generating binder layers comprising particles or layers comprising a photoconductive material such as vanadyl phthalocyanine, metal free phthalocyanine, benzimidazole perylene, amorphous selenium, trigonal selenium, selenium alloys such as selenium-tellurium, selenium-tellurium-arsenic, selenium arsenide, and the like and mixtures thereof are especially preferred because of their sensitivity to white light. Vanadyl phthalocyanine, metal free phthalocyanine and selenium tellurium alloys are also preferred because these materials provide the additional benefit of being sensitive to infra-red light.

Any suitable polymeric film forming binder material may be employed as the matrix in the photogenerating binder layer. Typical polymeric film forming materials include, but are not limited to, those described, for example, in U.S. Pat. No. 3,121,006, the entire disclosure of which is incorporated herein by reference. Thus, typical organic polymeric film forming binders include, but are not limited to, thermoplastic and thermosetting resins such as polycarbonates, polyesters, polyarnides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl acetate, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazole, mixtures thereof, and the like. These polymers may be block, random or alternating copolymers.

The photogenerating composition or pigment may be present in the resinous binder composition in various amounts. Generally, however, the photogenerating composition or pigment may be present in the resinous binder in an amount of from about 5 percent by volume to about 90 percent by volume of the photogenerating pigment dispersed in about 10 percent by volume to about 95 percent by volume of the resinous binder, and preferably from about 20 percent by volume to about 30 percent by volume of the photogenerating pigment is dispersed in about 70 percent by volume to about 80 percent by volume of the resinous binder composition. In one embodiment, about 8 percent by volume of the photogenerating pigment is dispersed in about 92 percent by volume of the resinous binder composition.

The photogenerating layer containing photoconductive compositions and/or pigments and the resinous binder material generally ranges in thickness of from about 0.1 micrometer to about 5.0 micrometers, and preferably has a thickness of from about 0.3 micrometer to about 3 micrometers. The photogenerating layer thickness is generally related to binder content. Thus, for example, higher binder content compositions generally require thicker layers for photogeneration. Thickness outside these ranges can be selected providing the objectives of the present disclosure are achieved.

Any suitable and conventional technique may be utilized to mix and thereafter apply the photogenerating layer coating mixture. Typical application techniques include spraying, dip coating, roll coating, wire wound rod coating, gravure coating, extrusion die coating and the like. Drying of the deposited coating may be effected by any suitable conventional technique such as oven drying, infra red radiation drying, air drying and the like.

The electrophotographic imaging member of the present disclosure contains a charge transport layer in addition to the charge generating layer. The charge transport layer comprises any suitable organic polymer or non-polymeric material capable of transporting charge to selectively discharge the surface charge. Charge transport layers may be formed by any conventional materials and methods, such as the materials and methods disclosed in U.S. Pat. No. 5,521,047 to Yuh et al., the entire disclosure of which is incorporated herein by reference. In addition, the charge transport layer may be formed as an aromatic diamine dissolved or molecularly dispersed in an electrically inactive polystyrene film forming binder, such as disclosed in U.S. Pat. No. 5,709,974, the entire disclosure of which is incorporated herein by reference. Further, although the following discussion refers to “a charge transport layer,” in embodiments two or more charge transport layers can be used, such as ones including varying amounts and types of charge transport or binder materials, and the like.

The charge transport layer of the disclosure generally includes at least a binder and at least one arylamine charge transport material. The binder should eliminate or minimize crystallization of the charge transport material and should be soluble in a solvent selected for use with the composition such as, for example, methylene chloride, chlorobenzene, tetrahydrofuran, toluene or another suitable solvent.

For example, suitable hole transport materials include, but are not limited to, pyrazolines such as 1-phenyl-3-(4′-diethylamino styryl)-5-(4″-diethylamino phenyl)pyrazoline; monoamines such as aryl monoamines including bis(4-methylphenyl)-4-biphenylylamine, bis(4-methoxyphenyl)-4-biphenylylamine, bis-(3-methylphenyl)-4-biphenylylamine, bis(3-methoxyphenyl)-4-biphenylylamine-N-phenyl-N-(4-biphenylyl)-p-toluidine, N-phenyl-N-(4-biphenylyl)-p-toluidine, N-phenyl-N-(4-biphenylyl)-m-anisidine, bis(3-phenyl)-4-biphenylylamine, N,N,N-tri[3-methylphenyl]amine, N,N,N-tri[4-methylphenyl]amine, N,N-di(3-methylphenyl)-p-toluidine, N,N-di(4-methylphenyl)-m-toluidine, bis-N,N-[(4′-methyl-4-(1,1′-biphenyl)]-aniline, bis-N,N-[(2′-methyl-4(1,1′-biphenyl) ]-aniline, bis-N,N-[(2′-methyl-4(1,1′-biphenyl)]-p-toluidine, bis-N,N-[(2′-methyl-4(1,1′-biphenyl)]-m-toluidine, N,N-di-(3,4-dimethylphenyl)-4-biphenylamine (DBA), N,N-bis[4-methylphenyl]-N-[3-phenyldecanoate]amine (TTA-decyl), tri-p-tolylamine (TTA), and the like; diamines such as aryl diamines including those described in U.S. Pat. Nos. 4,306,008, 4,304,829, 4,233,384, 4,115,116, 4,299,897, 4,265,990, 4,081,274 and 6,214,514, the entire disclosures of which are incorporated herein by reference, such as N,N′-diphenyl-N,N′-bis(alkylphenyl)-[1,1′-biphenyl]-4,4′-diamine wherein the alkyl is linear such as for example, methyl, ethyl, propyl, n-butyl and the like, N,N′-diphenyl-N,N′-bis(3-methylphenyl)-[1,1′-biphenyl]-4,4′-diamine, N,N′-diphenyl-N,N′-bis(3-hydroxyphenyl)-(1,1′-biphenyl)-4,4′-diamine, N,N′-diphenyl-N,N′-bis(4-methylphenyl)-[1,1′-biphenyl]-4,4′-diamine, N,N′-diphenyl-N,N′-bis(2-methylphenyl)-[1,1′-biphenyl]-4,4′-diamine, N,N′-diphenyl-N,N′-bis(3-ethylphenyl)-[1,1′-biphenyl]-4,4′-diamine, N,N′-diphenyl-N,N′-bis(4-ethylphenyl)-[1,1′-biphenyl]-4,4′-diamine, N,N′-diphenyl-N,N′-bis(4-n-butylphenyl)-[1,1′-biphenyl]-4,4′-diamine, N,N′-diphenyl-N,N′-bis(3-chlorophenyl)-[1,1′-biphenyl]-4,4′-diamine, N,N′-diphenyl-N,N′-bis(4-chlorophenyl)-[1,1′-biphenyl]-4,4′-diamine, N,N′-diphenyl-N,N′-bis(phenylmethyl)-[1′-biphenyl]-4,4′-diamine, N,N,N′,N′-tetraphenyl-[2,2′-dimethyl-1,1′-biphenyl]-4,4′-diamine, N,N,N′,N′-tetra(4-methylphenyl)-[2,2′-dimethyl-1,1′-biphenyl]-4,4′-diamine, N,N′-diphenyl-N,N′-(4-methylphenyl)-[2,2′-dimethyl-1,1′-biphenyl]-4,4′-diamine, N,N′-diphenyl-N,N′-bis(2-methylphenyl)-[2,2′-dimethyl-1,1′-biphenyl]-4,4′-diamine, N,N′-diphenyl-N,N′-bis(3-methylphenyl)-[2,2′-dimethyl-1,1′-biphenyl]-4,4′-diamine, N,N′-diphenyl-N,N′-bis(3-methylphenyl)-pyrenyl-1,6-diamine, 1,1-bis (4-(p-tolyl) aminophenyl) cyclohexane (TAPC), N,N′-bis(4-methylphenyl)-N,N′-bis(4-ethylphenyl)-[1,1′-(3,3′-dimethyl)biphenyl]-4,4′-diamine, and the like; triamines such as aromatic triamines; hydrazones such as N-phenyl-N-methyl-3-(9-ethyl)carbazyl hydrazone and 4-diethyl amino benzaldehyde-1,2-diphenyl hydrazone; oxadiazoles such as 2,5-bis (4-N,N′-diethylaminophenyl)-1,2,4-oxadiazole; stilbenes; mixtures thereof; and the like.

The hole transport materials of the charge transport layer are dispersed in a suitable binder material. The selection of binder or binders and hole transport materials should preferably eliminate or minimize crystallization or phase separation of the charge transport material in the layer. Further, the binder or binders should be soluble in a solvent selected for use with the composition such as, for example, methylene chloride, chlorobenzene, tetrahydrofuran, toluene or another suitable solvent. Suitable binders may include, for example, polycarbonates, polyesters, polyarylates, polyacrylates (including polymethacrylates), polyethers, polysulfones, polyvinyl chloride, polyvinylidene chloride, polystyrene, polyvinyl acetate, styrene-butadiene copolymer, styrene-alkyd resin, vinylidene chloride-acrylonitrile copolymer, vinyl chloride-vinyl acetate copolymer, vinyl chloride-vinyl acetate-maleic anhydride copolymer, silicones such as silicone hard coats, silicone-alkyd resin, phenol-formaldehyde resin, and mixtures thereof. Although any polycarbonate binder may be used, preferably the polycarbonate is either a bisphenol Z polycarbonate or a biphenyl A polycarbonate. Example biphenyl A polycarbonates are the MAKROLON® polycarbonates. Example bisphenol Z polycarbonates are the LUPILON® polycarbonates, also widely identified in the art as PCZ polycarbonates, e.g., PCZ-800, PCZ-500 and PCZ-400 polycarbonate resins and mixtures thereof. Examples of commercially available silicone hard coating agents include KP-85, X-40-9740 and X-40-2239 (produced by Shin-Etsu Silicone Co., Ltd.); AY42-440, AY42-441 and AY49-208 (produced by Toray Dow Corning Co., Ltd.); Dura-New-V-5 Hard coat (from California Hard coat Company); mixtures thereof; and the like.

When two or more binder materials are used, they can be used in any relative amounts to obtain the desired result. Thus, for example, two hole transport materials can be used in relative amounts of from about 1:10 to about 10:1 parts by weight, such as in relative amounts of from about 5:1 to about 1:5, or about 4:1 to about 1:4. However, amounts outside these ranges could also be used.

Typically, the charge transport material is present in the charge transport layer in an amount of from about 5 to about 80 percent by weight, and preferably from about 25 to about 75 percent by weight, and the binder is present in an amount of from about 20 to about 95 percent by weight, and preferably from about 25 to about 75 percent by weight, although the relative amounts can be outside these ranges. Any suitable and conventional technique may be utilized to mix and thereafter apply the charge transport layer coating mixture to the underlying layer. Typical application techniques include spraying, dip coating, roll coating, wire wound rod coating, and the like. Drying of the deposited coating may be effected by any suitable conventional technique such as oven drying, infra-red radiation drying, air drying and the like.

Generally, the thickness of the charge transport layer is between about 10 and about 50 micrometers, but thicknesses outside this range can also be used. The charge transport layer should preferably be an insulator to the extent that the electrostatic charge placed on the charge transport layer is not conducted in the absence of illumination at a rate sufficient to prevent formation and retention of an electrostatic latent image thereon. In general, the ratio of thickness of the charge transport layer to the charge generator layer is preferably maintained from about 2:1 to 200:1 and in some instances as great as 400:1. In other words, the charge transport layer is substantially non-absorbing to visible light or radiation in the region of intended use but is “active” in that it allows the injection of photogenerated holes from the photoconductive layer, i.e., charge generation layer, and allows these holes to be transported through the active charge transport layer to selectively discharge a surface charge on the surface of the active layer.

An optional overcoat layer may then be applied over the charge transport layer. The overcoating layer may contain organic polymers or inorganic film-forming materials that are electrically insulating or slightly conductive, optionally including various known filler materials. The thickness of the continuous overcoat layer selected may depend upon the abrasiveness of the charging (e.g., bias charging roll), cleaning (e.g., blade or web), development (e.g., brush), transfer (e.g., bias transfer roll), etc., system employed and can range up to about 10 micrometers. A thickness of between about 1 micrometer and about 5 micrometers in thickness is preferred, in embodiments. However, because the overcoating layer may be electron conductive, thicker overcoating layers can be employed in other embodiments. In these embodiments, the thickness can be between about 0.01 micrometer and about 20 micrometers in thickness.

Any suitable and conventional technique may be utilized to mix and thereafter apply the overcoat layer coating mixture to the charge transfer layer. Typical application techniques include spraying, dip coating, roll coating, wire wound rod coating, and the like. Drying of the deposited coating may be effected by any suitable conventional technique such as oven drying, infrared radiation drying, air drying and the like.

Other layers may also be used, such as a conventional electrically conductive ground strip along one edge of the belt or drum in contact with the conductive layer, blocking layer, adhesive layer or charge generating layer to facilitate connection of the electrically conductive layer of the photoreceptor to ground or to an electrical bias. Ground strips are well known and usually comprise conductive particles dispersed in a film forming binder.

In some cases, an anti-curl back coating may be applied to the side opposite the photoreceptor to provide flatness and/or abrasion resistance. These anti-curl back coating layers are well known in the art and may comprise thermoplastic organic polymers or inorganic polymers that are electrically insulating or slightly semiconductive.

The silicon oxide coating described above reduces the occurrence or the effect of charge deficient spots in the photoreceptor. Such charge deficient spots can be evaluated by a variety of techniques, such as described in U.S. Pat. Nos. 6,008,653, 6,150,824, and 5,703,487, the entire disclosures of which are incorporated herein by reference.

U.S. Pat. No. 6,008,653 to Popovic, et al. discloses a method for detecting surface potential charge patterns in an electrophotographic imaging member with a floating probe scanner. The scanner includes a capacitive probe, which is optically coupled to a probe amplifier, and an outer Faraday shield electrode connected to a bias voltage amplifier. The probe is maintained adjacent to and spaced from the imaging surface to form a parallel plate capacitor with a gas between the probe and the imaging surface. A constant voltage charge is applied to the imaging surface prior to establishing relative movement of the probe and the imaging surface. Variations in surface potential are measured with the probe and compensated for variations in distance between the probe and the imaging surface. The compensated voltage values are compared to a baseline voltage value to detect charge patterns in the electrophotographic imaging member.

U.S. Pat. No. 6,150,824 to Mishra, et al. discloses a contactless system for detecting electrical patterns on the outer surface of an imaging member which includes repetitively measuring the charge pattern on the outer surface with an electrostatic voltmeter probe maintained at a substantially constant distance from the surface, the distance between the probe and the imaging member being slightly greater than the minimum distance at which Paschen breakdown will occur to form a parallel plate capacitor with a gas between the probe and the surface.

U.S. Pat. No. 5,703,487 to Mishra discloses a process for ascertaining the microdefect levels of an electrophotographic imaging member comprising the steps of measuring either the differential increase in charge over and above the capacitive value or measuring reduction in voltage below the capacitive value of a known imaging member and of a virgin imaging member and comparing differential increase in charge over and above the capacitive value or the reduction in voltage below the capacitive value of the known imaging member and of the virgin imaging member.

Any suitable conventional electrophotographic charging, exposure, development, transfer, fixing and cleaning techniques may be utilize to form and develop electrostatic latent images on the imaging member of this disclosure. Thus, for example, conventional light lens or laser exposure systems may be used to form the electrostatic latent image. The resulting electrostatic latent image may be developed by suitable conventional development techniques such as magnetic brush, cascade, powder cloud, and the like.

While the disclosure has been described in conjunction with the specific embodiments described above, it is evident that many alternatives, modifications and variations are apparent to those skilled in the art. Accordingly, the preferred embodiments of the disclosure as set forth above are intended to be illustrative and not limiting. Various changes can be made without departing from the spirit and scope of the disclosure.

An example is set forth hereinbelow and is illustrative of different compositions and conditions that can be utilized in practicing the disclosure. All proportions are by weight unless otherwise indicated. It will be apparent, however, that the disclosure can be practiced with many types of compositions and can have many different uses in accordance with the disclosure above and as pointed out hereinafter.

### EXAMPLES

### Example 1

Preparation of Belt Coated Photoreceptor:

A belt electrophotographic imaging member is prepared. An imaging member is prepared by providing a 0.02 micrometer thick titanium layer coated on a biaxially oriented polyethylene naphthalate substrate (KALEDEX™ 2000) having a thickness of 3.5 mils. Over the titanium layer is applied, by conventional sputtering, a 35 Angstrom thick layer of SiOx.

After the SiOx layer is applied, a blocking layer is applied using a gravure applicator, from a solution containing 50 grams 3-amino-propyltriethoxysilane, 41.2 grams water, 15 grams acetic acid, 684.8 grams of 200 proof denatured alcohol and 200 grams heptane. This layer is then dried for about 5 minutes at 135° C. in a forced air drier of the coater. The resulting blocking layer has a dry thickness of 500 Angstroms.

An adhesive layer is then prepared by applying a wet coating over the blocking layer, using a gravure applicator, containing 0.2 percent by weight based on the total weight of the solution of copolyester adhesive (ARDEL D100 available from Toyota Hsutsu Inc.) in a 60:30:10 volume ratio mixture of tetrahydrofuran, monochlorobenzene, methylene chloride. The adhesive layer is then dried for about 5 minutes at 135° C. in the forced air dryer of the coater. The resulting adhesive layer has a dry thickness of 200 Angstroms.

A photogenerating layer dispersion is prepared by introducing 0.45 grams of LUPILON® 200 (PCZ 200) available from Mitsubishi Gas Chemical Corp. and 50 ml of tetrahydrofuran into a 4 oz. glass bottle. To this solution are added 2.4 grams of hydroxygallium phthalocyanine (OHGaPc) and 300 grams of 1/8 inch (3.2 millimeter) diameter stainless steel shot. This mixture is then placed on a ball mill for 8 to 10 hours. Subsequently, 2.25 grams of PCZ 200 is dissolved in 46.1 gm of tetrahydrofuran, and added to this OHGaPc slurry. This slurry is then placed on a shaker for 10 minutes. The resulting slurry is, thereafter, applied to the adhesive interface with a Bird applicator to form a charge generation layer having a wet thickness of 0.25 mil. However, a strip about 10 mm wide along one edge of the substrate web bearing the blocking layer and the adhesive layer is deliberately left uncoated by any of the photogenerating layer material to facilitate adequate electrical contact by the ground strip layer that is applied later. The charge generation layer is dried at 135° C. for 5 minutes in a forced air oven to form a dry charge generation layer having a thickness of 0.4 micrometer. The optical density of the applied charge generating layer is 1.18.

This photogenerator layer is overcoated with a charge transport layer. The charge transport layer is prepared by introducing into an amber glass bottle in a weight ratio of 50:50 N,N′-diphenyl-N,N′-bis(3-methylphenyl)-1,1′-biphenyl-4,4′-diamine and Makrolon 5705, a polycarbonate resin having a molecular weight of from about 50,000 to 100,000 commercially available from Farbenfabriken Bayer A. G. The resulting mixture is dissolved in methylene chloride to form a solution containing 15 percent by weight solids. This solution is applied on the photogenerator layer using a Bird applicator to form a coating that upon drying has a thickness of 14.5 microns. During this coating process the humidity is equal to or less than 15 percent.

This charge transport layer is overcoated with a second charge transport layer. The second charge transport layer is prepared by introducing into an amber glass bottle in a weight ratio of 50:50 N,N′-diphenyl-N,N′-bis(3-methylphenyl)- 1, ′-biphenyl-4,4′-diamine and Makrolon 5705, a polycarbonate resin having a molecular weight of from about 50,000 to 100,000 commercially available from Farbenfabriken Bayer A.G. The resulting mixture is dissolved in methylene chloride to form a solution containing 15 percent by weight solids. This solution is applied on the first charge transport layer using a Bird applicator to form a coating which upon drying has a thickness of 14.5 microns. During this coating process the humidity is equal to or less than 15 percent.

### Examples 2-3

Preparation of Belt Coated Photoreceptors:

Two additional photoreceptors are prepared in the same manner of Example 1, except that the thickness of the SiOx layer is altered. In Example 2, the SiOx layer is 50 Angstroms thick. The optical density of the charge generating layer is 1.19. In Example 3, the SiOx layer is 100 Angstroms thick. The optical density of the charge generating layer is 1.17.

### Comparative Examples 1-2

Preparation of a Belt Coated Photoreceptor Without SiOx Layers:

For comparison, two reference belt imaging devices are prepared in the same manner of Example 1, except that the SiOx layer is omitted.

Comparative Testing:

Following completion of the imaging members, the coating appearance of the imaging members of Examples 1-3 (with SiOx layer) and Comparative Examples 1-2 (without SiOx layer) are observed to be clear with a very uniform appearance.

The samples are tested on a Floating Probe CDS Scanner. This scanner records all the charge deletion spot (CDS) counts directly on the photoreceptors through a floating micro probe. This testing results (number of CDS per square centimeter) are shown in the following Table:

| | Example | | | | |
|---|---|---|---|---|---|
| | 1 | 2 | 3 | Comp 1 | Comp 2 |
| SiOx | 35 | 50 | 100 | 0 | 0 |
| (Angstroms) | | | | | |
| CDS/cm² | 10.1 | 10.5 | 4.8 | 13.7 | 12.8 |

The testing shows that the CDS is reduced by over 50% with the 100 Angstrom thick SiOx layer. This test shows that the occurrence and/or effect of charge deletion spots is significantly reduced by the incorporation of a SiOx layer between the conductive ground plane and the blocking layer.

Two of the samples (Example 3 and Comparative Example 1) are used to form closed-loop imaging member belts, which are tested in a Xerox Nuvera® machine. The closed loop machine testing shows a high CDS Ranking of 4 for the belt of Comparative Example 1, but a significantly lower CDS ranking of 2 for the belt of Example 3 as measured from prints. This testing also shows significantly improved CDS reduction, without any problem of using the imaging. belt in the development machine.

### Example 4

Preparation of Belt Coated Photoreceptor:

An imaging member is prepared by providing a 0.02 micrometer thick chromium layer coated on a biaxially oriented polyethylene naphthalate substrate (KALEDEX™ 2000) having a thickness of 3.5 mils. Over the chromium layer is applied, by conventional sputtering, a 120 Angstrom thick layer of SiOx deposited by e-Beam coating. Then on the SiOx layer is coated a charge generating layer with an optical density of 1.18 and a 29 micron think single charge transport layer, as in example 3. The device is tested by the technique of FIDD described in U.S. Pat. No. 5,703,487, the entire disclosure of which is incorporated herein by reference. The results are shown in the table below.

### Comparative Example 3:

A comparative sample is coated in the same manner as in example 4, but with no SiOx layer coated on the substrate before deposition of the charge generating and charge transport layers. The comparative sample is tested as in Example 4, and the results are shown in the table below.

The FIDD values shown in the Table are described as the value of dark decay obtained at the high voltage of 1600 volts across the devices.

| Sample | Qualification | Fidd |
|---|---|---|
| Example 4 | With SiOx Layer | 23 |
| Comparative Example 3 | No SiOx Layer | 700 |

The higher values of FIDD are associated with the higher number of charge deficient spots, as discussed in U.S. Pat. No. 5,703,487. Thus, the results show a significant improvement of CDS reduction with the SiOx layer coated with e-beam technique.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An imaging member comprising:
a conductive substrate,
a SiOx layer coated over said conductive substrate;
a charge generating layer coated over said SiOx layer, and
a charge transport layer.

2. The imaging member of claim 1, further comprising a blocking layer coated between said SiOx layer and said charge generating layer.

3. The imaging member of claim 1, further comprising an adhesive layer coated between said SiOx layer and said charge generating layer.

4. The imaging member of claim 1, wherein the SiOx layer consists essentially of SiOx.

5. The imaging member of claim 1, wherein x in SiOx represents a value from about 0.01 to about 2.

6. The imaging member of claim 1, wherein the SiOx layer is applied by a process selected from the group consisting of, sputtering, e-beam deposition, evaporation vapor deposition, ion plating, and chemical vapor deposition.

7. The imaging member of claim 1, wherein the SiOx layer is applied by a process selected from the group consisting of sputtering and e-beam deposition.

8. The imaging member of claim 7, wherein the SiOx layer is applied by sputtering, and wherein the precursor materials used in the sputtering comprise silicon or silicon oxides.

9. The imaging member of claim 1, wherein the SiOx layer has a thickness of from about 10 and about 500 Angstroms.

10. The imaging member of claim 1, wherein the SiOx layer has a thickness of from about 35 and about 200 Angstroms.

11. The imaging member of claim 1, wherein the SiOx layer has a thickness greater than about 75 Angstroms.

12. A process for forming an imaging member, comprising:
providing an imaging member conductive substrate,
applying a SiOx layer coated over said conductive substrate; and
applying at least a charge generating layer and a charge transport layer over said SiOx layer.

13. The process of claim 12, further comprising applying a blocking layer over said SiOx layer before applying said charge generating layer and said charge transport layer.

14. The process of claim 12, further comprising applying an adhesive layer over said SiOx layer before applying said charge generating layer and said charge transport layer.

15. The process of claim 12, wherein the SiOx layer consists essentially of siox.

16. The process of claim 12, wherein the SiOx layer is applied by a process selected from the group consisting of, sputtering, e-beam deposition, evaporation vapor deposition, ion plating, and chemical vapor deposition.

17. The process of claim 12, wherein the SiOx layer is applied by a process selected from the group consisting of e-beam deposition and sputtering.

18. The process of claim 17, wherein the SiOx layer is applied by sputtering, and wherein the precursor materials used in the sputtering comprise silicon or silicon oxides.

19. The process of claim 12, wherein the SiOx layer has a thickness of from about 10 and about 500 Angstroms.

20. The process of claim 12, wherein the SiOx layer has a thickness of from about 35 and about 200 Angstroms.

21. An electrographic image development device, comprising the imaging member of claim 1.
